(19) United States
(12) Patent Application Publication
(10) Pub. No.: US 2002/0127045 A1
(43) Pub. Date: Sep. 12, 2002

(54) Bingo card marker

(76) Inventors: John L. Cookfair, Buffalo, NY (US); Thomas O'Shei, West Seneca, NY (US)

Correspondence Address: ARTHUR S. COORFAIR, 201 GLENALBY RD, TONAWANDA, NY, 14150, US

(21) Appl. No.: 10/094,745

(22) Filed: Mar. 11, 2002

Related U.S. Application Data
(60) Provisional application No. 60/275,267, filed on Mar. 12, 2001.

(51) Int. Cl. B05C 21/00

(52) U.S. Cl. 401/202; 401/196; 401/183

(57) ABSTRACT

A hand held bingo card marker comprises:

A) an elongated body portion having a generally central longitudinal axis within a surrounding side wall, a top end, and a bottom end defining an ink reservoir; and

B) a head portion extending from the elongated body portion and including a neck channel and dauber extending at an angle of about 40° to 60° from the body portion the dauber being in fluid communication with the ink reservoir when the marker is inclined and the dauber is pressed against a surface.

The marker is ergonomically advantageous and characterized by ease of use.

This application claims the benefit of U.S. Provisional Application No. 601275,267, filed Mar. 12 2001.

### BACKGROUND OF THE INVENTION

1. Field of the Invention

This invention relates to devices for marking on surfaces and in particular to hand held marking devices suitable for use in marking papers or cards, such as bingo cards and the like.

2. Background and Prior Art.

In the game of bingo, each player has a bingo card having printed thereon a number of squares arranged in rows and columns, typically numbering 25 squares arranged in five columns and five rows, with the columns being identified at the top by a letter and within the square by a number. As the game is played, a bingo caller calls out a number and the letter designating the column in which the number may be found. A player whose card contains a square that matches the number and column, records the call by marking or otherwise designating the square. Traditionally, the recording of a particular call was accomplished by covering the corresponding square with a small plastic or paper disc. More recently, it has become common practice to record or identify a square that has been called by placing an ink mark on the square, using an ink marking device, often referred to as a “bingo dabber” or “bingo marker”. Typically, such a bingo card marker is a hand held cylindrical plastic bottle, filled with a suitable marking ink and having a check-valve operated applicator head, generally of foam material. To record a called number, the user inverts the bottle and presses the head on the appropriate square. A spot of colored ink is transferred to the square. To keep up with the speed of the game, the marking procedure must be carried out rapidly and accurately. Thus the ease with which the player can manipulate the marking device is important.

A variety of bingo marker devices are in common use and are, in general, suitable for their intended purpose. However, it will be appreciated that improvements would be helpful with respect to such factors as cost of manufacture, ergonomic design, and ease of use.

U.S. Pat. No. 5,899,619 to O'Shei discloses a hand held marking device including two independent refillable ink reservoirs, for holding differently colored inks. Each reservoir is associated with separate depositing means or applicator head. The applicator heads are both at the same end of the marking device and are angled away from each other with a bumper extension therebetween to prevent both depositing means from simultaneously contacting the surface to be marked.

U.S. Pat. No. 4,863,171 to Rocheleau, discloses a bingo dabber for marking items such as bingo cards, the dabber being in the general form of a hammer with the head provided with two oppositely directed ink applicators.

U.S. Pat. No. 5,713,681 to Venne et al. discloses a bingo card marker bottle ergonomically designed for ease of holding during use. The bottle is of molded plastic and comprises an ink reservoir with an ink applicator mounted on the neck of the bottle.

In addition to liquid applicators designed for use as marking devices, such as for use as bingo markers and the like, liquid applicators may be designed with a different flow through of liquid, for such uses as shoe polish containers and/or applicators. Liquid containers and applicators which may be suitable for use in the polishing of shoes or for other purpose are known and are disclosed, for example, in patents, such as Design Pat. No. 308,330 and 308,476.

### SUMMARY OF THE INVENTION

It is an object of this invention to provide a marking device suitable for use as a bingo card marker that is characterized by convenience and ease of use.

It is a further object to provide a marking device suitable for use as a bingo card marker, highlighter, or the like that is ergonomically advantageous.

It is a further object to provide a bingo card marker that is relatively inexpensive to manufacture.

The above and other objects are achieved in accordance with the present invention which provides a bingo card marker comprising:

a) an elongated body portion having a generally central longitudinal axis within a surrounding side wall, a top end, and a closed bottom end defining a liquid reservoir;

b) a head portion extending from the top end of the elongated body portion and enclosing a neck channel and having a dauber means at the terminus thereof, the neck channel and dauber means having a generally central neck channel axis, extending at an angle from the central longitudinal axis of the elongated body portion, the dauber means being in fluid communication through the neck channel with the liquid reservoir when the marker is inclined and the dauber means is pressed against a surface.

The head portion, including the neck channel and dauber means, having a generally central neck channel axis, extends from the top end of the body portion at an angle, to provide greater ease of use. Thus, for example, when a mark is to be made on a horizontal surface, such as the surface of a bingo card during play, it is preferable that the dauber and neck channel axis be approximately perpendicular to the surface of the card when it is pressed against the surface. To accomplish this, the marker is tilted so that the dauber and neck channel axis are approximately perpendicular to the surface of the card when the dauber is pressed against the card. The degree of tilt required to orient the dauber in this manner is dependent on the angle of inclination of the head portion, that is, the angle to which the central neck channel axis is inclined from the central longitudinal axis of the body portion. A lack of any angle of inclination, as in most prior art markers has been found less than satisfactory since it requires completely inverting the marker so that the longitudinal axis is perpendicular to surface to be marked. At the other extreme, markers wherein the central neck channel axis is at a ninety degree angle to the longitudinal axis of the body portion, in a hammer-like configuration, have been found awkward and inconvenient to control during play. A moderate angle is preferred.

In accordance with the present invention, the angle may vary, but is preferably between about 40° and 60°, and most preferably between about 40° and 50° Thus, for example, during play, the marker may be held in the user's hand and the dauber may be quickly and conveniently pressed perpendicularly against the bingo card by moderately tilting the marker (for example, with the longitudinal axis at about 40° to 60° from horizontal) without the need to totally invert the elongated body portion to a vertical orientation when the dauber is pressed against the card.

In another aspect the present invention relates to a convenient method for marking a bingo card comprising holding an elongated bingo card marker as described herein having longitudinal axis, in a position whereby the longitudinal axis is inclined at an angle of about 40° to about 60° from horizontal and pressing the dauber against the bingo card at a selected location so that the dauber presses on the card with the neck channel axis at an angle approximately perpendicular to the surface. The use of the marker of the present invention, in this manner, provides a greater ease of manipulation compared to other markers. In practice, the angled neck and dauber allow the marker to be applied to mark the horizontal surface of a bingo sheet with less stress on the hand and wrist of the user. Moreover, when the marker of the present invention is pressed against the horizontal surface of a bingo sheet, the body portion of the marker is at a 40 to 60 degree angle to the horizontal surface and, as a result, increases the visibility of the playing surface of bingo sheet during play.

In a preferred embodiment, the elongated body portion of the marker of the present invention is generally cylindrical or barrel-shaped and of suitable diameter to permit the user to conveniently grip the marker with the thumb, index finger, and middle finger in the manner commonly used to hold a writing instrument, such as a pencil, allowing an ease of control inherent in such a grip. In a further preferred embodiment, the cylindrical elongated body portion may be provided with one or more, preferably three, flattened surfaces, arranged to conform to a user's finger grip, especially using the first three fingers, that is, the thumb, index finger and middle finger of either hand positioned on the flattened surfaces.

### BRIEF DESCRIPTION OF THE DRAWINGS

The present invention and the manner in which it may be practiced is further illustrated with reference to the accompanying drawings wherein:

FIG. 1 is a side elevational view of an embodiment of the bingo card marker of the present invention, with the cap being partially cut-away, the opposite side view being a mirror image;

FIG. 2 is a front elevational view of the embodiment of the bingo card marker of FIG. 1;

FIG. 3 is a rear view of the embodiment of FIGS. 1 and 2;

FIG. 4 is a side elevational view of an alternative embodiment of the bingo card marker of the present invention, with the cap removed, the opposite side view behind a mirror image.

FIG. 5 is a Sectional view taken along line 5-5 of FIG. 4.

### DETAILED DESCRIPTION OF THE INVENTION

With reference to FIGS. 1-4, the embodiments of the bingo card marker 2 of the present invention comprise an elongated body portion 3 having a top end 4 and a closed bottom end 5 enclosing a liquid reservoir 6, shown in partial cutaway in FIG. 1, for holding a volume of marking ink. The elongated body portion 3 is characterized by a central longitudinal axis 51. Optionally, the closed bottom end 5 may be extended slightly to provide a base 7 for setting the marker on a surface in a “stand-up” position. At the top end 4 of the body portion 3 is attached an inclined head portion 8 having a neck channel 11 terminating in a dauber 9. Neck channel 11 and terminal dauber 9 are characterized by a generally central neck channel axis 62. The head portion 8 is inclined from the elongated body portion 3, preferably at an angle of between about 40° and about 60° (between neck channel axis 62 and longitudinal axis 51, as shown in FIG. 1) so that the dauber may be conveniently applied to a surface for marking without totally inverting the marker 2. When not in use, the dauber 9 may be protected by a cap 10.

In FIG. 1, cap 10 is shown in partial cutaway to show dauber 9 mounted on the end of a neck channel 11. The cap 10 may be held in place by internal threads (not shown) mating with external threads 15 on neck 11. Alternatively, the cap may be attachable by various other means, such as by a pressure fit.

Dauber 9 may be of made of a felt, rubber, sponge, foam or other suitable material sufficiently porous to become saturated with ink, but not so porous as to allow the ink to flow unrestricted therethrough. Thus, upon pressing against a surface, dauber 9 places a controllable amount of ink on the surface to be marked.

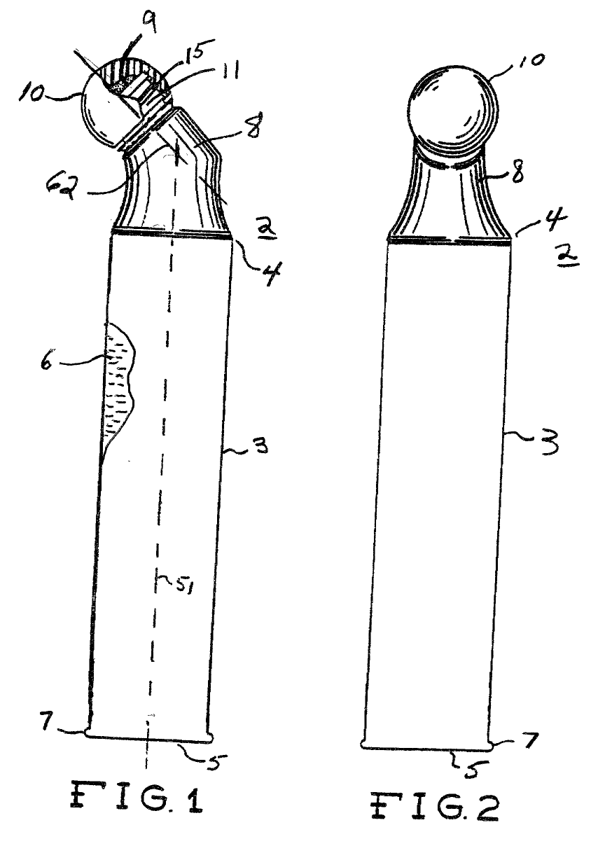

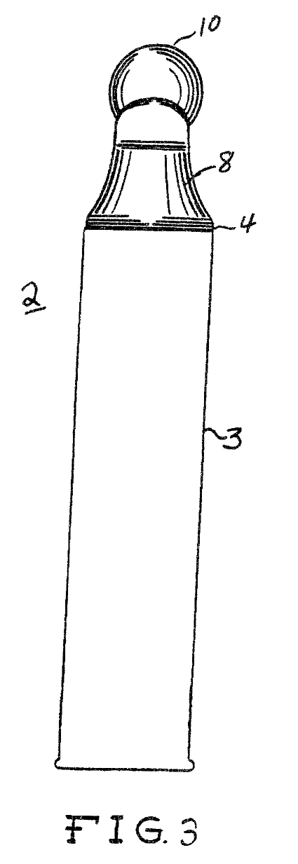

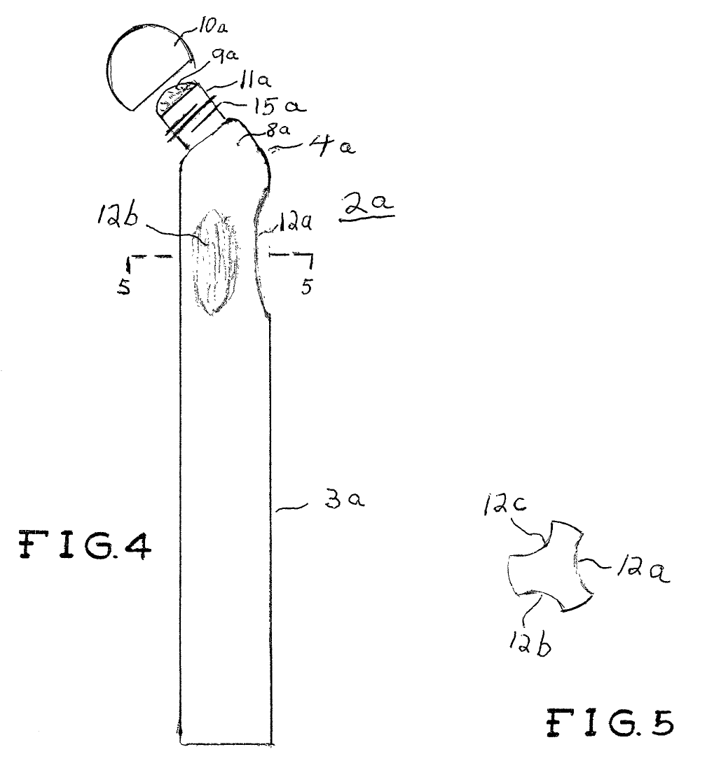

With reference to FIGS. 4 and 5, there is depicted a preferred embodiment of the invention ergonomically designed for ease of use, especially by users whose hands are weak and/or handicapped, for example, as a result of arthritis or other handicapping health condition. In the marker of FIG. 4, cap 10a is shown removed from neck channel 11a. Neck channel 11a is provided with external threads 15a to engage internal threads (not shown) in cap 10a. Optionally, Cap 10a may be adapted cover the dauber 9a by a pressure fit or snap fit or other suitable closure means onto neck channel 11a. In the embodiment shown, most of the elongated body portion 3a is generally cylindrical in shape, with three finger-gripping surfaces 12a, 12b, and 12c that may be flattened or depressed areas preferably on the upper portion of the cylindrical elongated body portion 3a, that is, in the region closer to the top end 4a. In practice, the marker 2a may be gripped in the user's right hand with the user's index finger positioned on depressed surface 12a, thumb on depressed surface 12b, and middle finger on depressed surface 12c. Alternatively, the marker may be held in the user's left hand with the index finger positioned on surface 12a, thumb on surface 12c, and middle finger on surface 12c. Optionally, one or more of these depressd gripping surfaces may be provided with means such as ridges or roughened surface, or suitable coating to further improve the user's ability to grip the marker in the manner intended. Although the gripping surfaces are generally similar in shape and location, it has been found efficacious to make depressed gripping surface 12a extend somewhat closer to top end 4a, to provide an improved positioning for the index finger.

Alternatively, the gripping surface may be provided in the form of a soft foam covering or an encapsulated gel coating surrounding the body portion at the gripping region, that is in the upper portion of the cylindrical body portion 3a in the region closer to the top end 4a. In this case, pressure from the fingers of the user would create a gripping configuration during use.

The main body of the bingo card marker, including the body portion 3, head portion 8 and neck channel 11 as well as the cap 10, may formed of any of a variety of materials, including for example, plastics, which may be conveniently shaped by extrusion, blow molding, injection molding or other methods known in the art. Furthermore, in the interests of economy, all or part of the marker may be fabricated from an inexpensive material such as cardboard, coated as necessary to render it impervious to liquid, for use as an inexpensive disposable marker that may be thrown away after a very few hours of use.

Although the invention has been described with reference to certain preferred embodiments thereof, it will be appreciated that modifications and variations may be made without departing from the spirit and scope of the invention as disclosed herein.

what is claimed is:

1. A bingo card marker comprising:
A) an elongated body portion having a generally central longitudinal axis within a surrounding side wall, a top end, and a closed bottom end defining a liquid reservoir; and
B) a head portion extending from the top end of the elongated body portion and including a neck channel having a dauber at a terminus thereof, the neck channel and dauber having a generally central neck channel axis, extending at an angle from the central longitudinal axis of the elongated body portion, the dauber being in fluid communication through the neck channel with the liquid reservoir when the marker is inclined and the dauber is pressed against a surface.

2. A bingo card marker according claim 1 wherein said angle is between about 40 and 60 degrees.

3. A bingo card marker according to claim 1 wherein said neck channel axis extends at an angle of between about 40° and 50° from said longitudinal axis of said body portion.

4. A bingo card marker according to claim 1 wherein said elongated body portion is generally cylindrical in cross-sectional shape.

5. A bingo card marker according to claim 4 wherein said elongated body portion is provided with finger-gripping surfaces adapted for gripping with a user's thumb, index finger, and middle finger.

6. A bingo card marker according to claim 5 wherein said finger-gripping surfaces are positioned in a position generally adjacent to said top end of said elongated body portion.

7. A bingo card marker according to claim 6 wherein said finger-gripping surfaces comprise three approximately flattened portions on the periphery of said cylindrical elongated body portion generally adjacent to said top end and forming a substantially triangular cross-sectional shape providing surfaces for gripping with the user's thumb, index finger, and middle finger.

8. A bingo card marker according to claim 7 wherein one of said approximately flattened surfaces extends closer to said top end and and is aligned in the axial plane of said central longitudinal axis and said neck channel axis for gripping by the user's index finger.

9. A bingo card marker according to claim 6 wherein said finger-gripping surfaces comprise a soft foam covering surrounding said elongated body portion in a position generally adjacent to said top end.

10. A bingo card marker according to claim 6 wherein said finger-gripping surfaces comprise an encapsulated soft gel coating surrounding said elongated body portion in a position generally adjacent to said top end.

11. A bingo card marker according to claim 2 further comprising a cap, removably securable to said neck channel to cover said dauber.
